(19) United States
(12) Patent Application Publication
(10) Pub. No.: US 2025/0156753 A1
(43) Pub. Date: May 15, 2025

(54) DETECTING OUTLIERS DURING MACHINE LEARNING SYSTEM TRAINING

(71) Applicant: International Business Machines Corporation, Armonk, NY (US)

(72) Inventors: Lukasz G. Cmielowski, Kraków (PL); Daniel Jakub Ryszka, Kraków (PL); Szymon Kucharczyk, Kraków (PL); Dorota Laczak, Mielec (PL)

(21) Appl. No.: 18/543,439

(22) Filed: Dec. 18, 2023

(30) Foreign Application Priority Data
Nov. 15, 2023 (GB) 2317473.3

(51) Int. Cl. G06N 20/00

(52) U.S. Cl. CPC G06N 20/00

(57) ABSTRACT

One or more computer processors receiving training data comprising a trial subset of training data. The one or more computer processors probe the trial subset of training data using a machine learning system and multiple robust measures of scale formulas to select an upper bound for data outlier detection and to select a lower bound for data outlier selection. The one or more computer processors detect one or more outliers in the training data using the selected upper bound and the selected lower bound. The one or more computer processors generate modified training data using the detected outliers. The one or more computer processors train the machine learning system utilizing the modified training data.

### BACKGROUND

The present invention relates generally to the field of machine learning systems, and more particularly to detecting outliers during machine learning system training.

Outliers in training data are data which have unexpected values. Outliers could be data with errors or incorrect values, or it could be that the outliers actually are correct. The presence of outliers, if they contain erroneous or incorrect data, can possibly lead to a machine learning system providing skewed or incorrect predictions or results. Properly detecting outliers can be challenging. In addition, dealing with outliers may also be difficult because every record of the training data, even if it is an outlier, may be significant.

### SUMMARY

Embodiments of the present invention disclose a computer-implemented method, a computer program product, and a system. The computer-implemented method includes one or more computer processers receiving training data comprising a trial subset of training data. The one or more computer processors probe the trial subset of training data using a machine learning system and multiple robust measures of scale formulas to select an upper bound for data outlier detection and to select a lower bound for data outlier selection. The one or more computer processors detect one or more outliers in the training data using the selected upper bound and the selected lower bound. The one or more computer processors generate modified training data using the detected outliers. The one or more computer processors train the machine learning system utilizing the modified training data.

### BRIEF DESCRIPTION OF THE DRAWINGS

In the following embodiments of the invention are explained in greater detail, by way of example only, making reference to the drawings in which:

FIG. (i.e., FIG.) 1 illustrates an example of a computing environment, in accordance with an embodiment of the present invention;

FIG. 2 shows a further view of the computing environment illustrated in FIG. 1; and

FIG. 3 shows a flow chart which illustrates a method of using the computing environment illustrated in FIGS. 1 and 2.

### DETAILED DESCRIPTION

In one aspect the invention provides for a computer-implemented method of training a machine learning system. The method comprises receiving training data. The training data comprises a trial subset of training data. The method further comprises probing the trial subset of training data using the machine learning system, the trial subset of training data, and multiple robust measures of scale formulas to select an upper bound for the data outlier detection and to select a lower bound for the data outlier selection. The method further comprises detecting outliers in the training data using the upper bound and the lower bound. The method further comprises generating modified training data using the detected outliers. The method further comprises training the machine learning system using the modified training data.

According to a further aspect of the present invention, the invention provides for a computer program product that comprises a computer-readable storage medium that has computer-readable program code embodied on it. The computer-readable program code is configured to implement a method according to an embodiment.

According to a further aspect of the invention, the invention provides for a computer system. The computer system comprises a processor configured for controlling or operating the said computer system. The computer system further comprises a memory storing machine-executable instructions. The execution of the instructions causes the processor to receive training data. The training data comprises a trial subset of training data. Execution of the instructions further causes the processor to probe the trial subset of training data using the machine learning system, the trial subset of training data, and multiple robust measures of scale formulas to select an upper bound for data outlier detection and to select a lower bound for data outlier selection.

Execution of the instructions further causes the processor to detect outliers in the training data using the upper bound and the lower bound. Execution of the instructions further causes the processor to generate modified training data using the detected outliers. Execution of the instructions further causes the processor to train the machine learning system using the modified training data.

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Examples may provide for a method of training a machine learning system. In some examples the machine learning system may be an individual machine learning module or implementation such as a neural network. In other examples, the machine learning system may be more complicated. For example, the machine learning system may be an automated machine learning system where the system is automatically able to receive training data and then select and train the best model to represent or model the training data.

The method comprises receiving training data. The training data comprises a trial subset of training data. The training data may for example include data to be input into a machine learning module and the ground truth data which the output of the model can be compared against during training. The method may further comprise probing the trial subset of training data using the machine learning system, the trial subset of training data, and multiple robust measures of scale formulas to select an upper bound for data outlier detection and to select a lower bound for data outlier detection.

The training data is the data which is used to train the machine learning system and the trial subset is just a small or fractional portion of the training data. The probing is used in some examples to test the multiple robust measures of scale formulas to select the best one to use to find an upper bound for the data outlier detection and to select the lower bound for the data outlier detection. A robust measure of scale formula is a statistical formula which is used to quantify a statistical dispersion of a sample in numerical data while simultaneously resisting or detecting outliers. For example, the robust measure of scale formula is a formula which is used to detect if data is an outlier or not.

The method may further comprise detecting outliers in the training data using the upper bound and the lower bound. The method further comprises generating modified training data using the detected outliers. The generation of the modified training data may encompass both modifying the training data by deleting or removing training data which is detected to be outliers, or it may also encompass it flagging or indicating particular training data that is detected as being an outlier. The method may further comprise training the machine learning system using the modified training data.

Examples may have the benefit that there may be improved detection of outliers in the training data. The use of multiple robust measures of scale formulas may have the advantage that these may be independently tested to see which one provides the best results. This may provide for a superior means of selecting the upper bound and the lower bound for data outlier detection. This may result in a machine learning system which is trained more accurately or more robustly.

In a further example the probing comprises selecting an optimal formula from the multiple robust measures of scale formula by determining trial upper and lower bounds using at least multiple of the multiple robust measures of scale formulas.

For example, more than one of the multiple robust measures of scale formulas are compared. The probing further comprises generating trial training data using the trial upper and lower bounds for the at least multiple robust measures of scale formulas. The probing further comprises training the machine learning system with the trial training data for the at least multiple robust measures of scale formulas. The method further comprises determining an accurate score for the machine learning system trained with the trial training data for the at least multiple robust measures of scale formulas using the training data. The method further comprises selecting the optimal formula from the at least multiple robust measures of scale formula using the accuracy score.

This example may be beneficial because it selects the optimal formula from the multiple robust measures of scale by determining which provides for the most accurate modeling of the training data.

This example may be beneficial because it selects the optimal formula from the multiple robust measures of scale by determining which provides for the most accurate modeling of the training data.

This example may also be beneficial because it may provide for a means of automating the selection of a robust measure of scale formula. For example, the choice of a robust measure of scale formula could also be included as a hyper parameter during the training of the machine learning system.

The optimal formula may comprise parameters. Here, the probing may comprise optimizing the parameters during iterative training of the machine learning system with the trial subset with variations in the parameters. After the optimal formula has been selected further tests of the accuracy score may be made for variations in the parameters of the optimal formula. This may provide for further fine tuning of the optimal formula such that the best results for the upper and lower bounds is obtained.

In another example, generating the modified data using the detected outliers comprises labeling the detected outliers with a missing value imputer. The machine learning system is configured for handling the missing value imputer during training. Various types of machine learning modules such as neural networks may sometimes be trained to handle missing values. This may be, for example, preferable to leaving these data out during the training. Depending upon the example the labeling may take different forms. In some examples the actual value may be replaced with the missing value imputer. In other examples the missing value imputer may simply be an additional flag so that the original data is still present also.

In another example the missing value imputer is a not-a-number identifier. The use of a not-a-number identifier may be beneficial because it provides for a means of labeling an outlying data or training data without it being mistaken for being valid data.

In another example, the machine learning system is a pipeline machine learning system where the pipeline machine learning system comprises multiple computational units arranged in a pipeline. A pipeline as used herein may encompass a path or channel for data to follow. If computational units are arranged in a pipeline, it means that they process the output of the previous unit and then pass it to another unit. Essentially the multiple computational units arranged in a pipeline process data sequentially. The multiple computational units comprise a transformer configured to enable or disable the effect of the missing value imputer on output of the machine learning system. This may be beneficial because it is then very easy to test the computational system to see if the outlier detection is beneficial for training the machine learning system.

In another example the method further comprises generating a test group of data from the training data. The method further comprises testing a first accuracy of the machine learning system with the transformer configured to enable the effect of the missing value imputer using the test group of data. The method further comprises testing a second accuracy of the machine learning system with the transformer configured to disable the effect of the missing imputer using the test group of data. The method further comprises disabling the effect of the missing value imputer in the transformer if the second accuracy is greater than the first accuracy. The method further comprises enabling the effect of the missing value imputer in the transformer if the first accuracy is greater than the second accuracy. This example may be beneficial because it may provide for a means of automatically determining if the missing value imputer benefits the machine learning system with greater accuracy or not.

In another example, the generation of modified training data using the detected outliers comprises deleting the training data containing the identified outliers. This may be beneficial because it may enable training simpler models that are not able to handle a missing value imputer. It may nonetheless obtain the benefit of using the best formula from the multiple robust measures of scale.

In another example the machine learning system is an automated machine learning system. The automated machine learning system is configured for automatically selecting an optimal machine learning module from multiple machine learning modules during training of the machine learning system using the modified training data.

In another example, the multiple robust measures of scale formulas comprise an InterQuartile Range (IQR).

In another example, the multiple robust measures of scale formulas comprise a Robust Covariance equation.

In another example, the multiple robust measures of scale formulas comprise a Local Outlier Factor.

In another example, the multiple robust measures of scale formulas comprise a standard deviation equation. For example, outliers can be set to be outside of certain numbers of standard of deviation.

In another example, the multiple robust measures of scale formulas comprise a mean absolute deviation.

In another example, the multiple robust measures of scale formulas comprise a Cauchy distribution.

In another example, the multiple robust measures of scale formulas comprise a biweight midvariance.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a machine learning system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for implementing a method of using the machine learning system 200 may be stored in persistent storage 113. For example, instructions may be used to control the computing environment to receive training data. The training data comprises a trial subset of training data. Instructions may be further used to control the computing environment to probe the trial subset of training data using the machine learning system and multiple robust measures of scale formulas to select an upper bound for data outlier detection and to select a lower bound for data outlier selection.

Instructions may further be used to control the computing environment to detect outliers in the training data using the upper bound and the lower bound. Instructions may be used to control the computing environment to generate modified training data using the detected outliers. Instructions may be used to control the computing environment to train the machine learning system using the modified training data.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

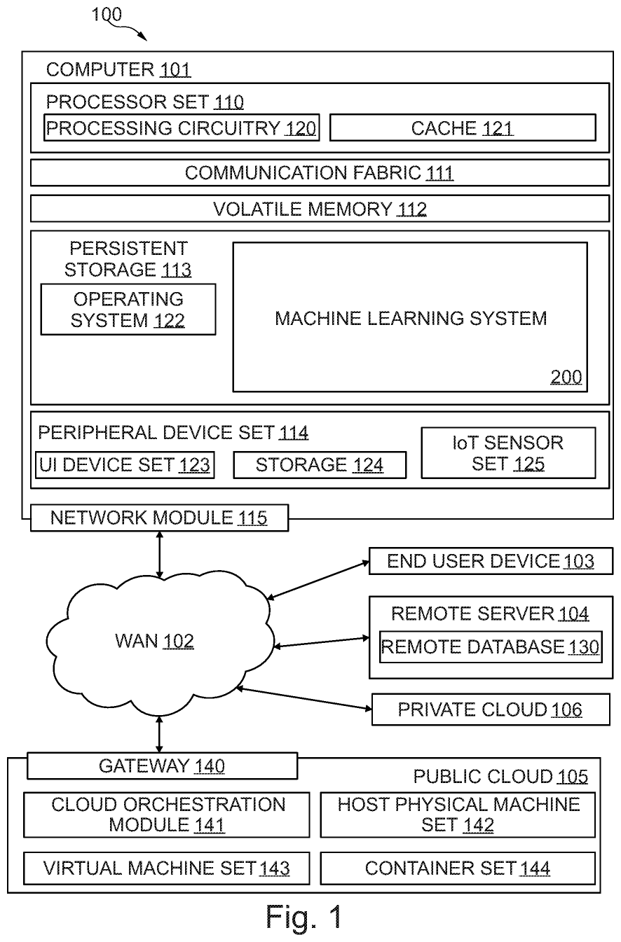

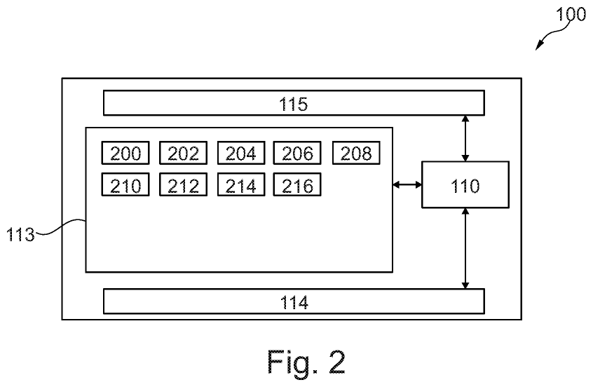

FIG. 2 shows a further view of the computing environment 100. Not all features of the computing environment 100 are illustrated in FIG. 2. The persistent memory 113 is further shown as containing machine-executable instructions 202. The machine-executable instructions for example enable the processor set 110 to manipulate and control the machine learning system 200. The persistent memory 113 is further shown as containing training data 204 for training the machine learning system 200.

The persistent storage 113 is further shown as containing a trial subset of training data 206. The persistent storage 113 is further shown as containing multiple robust measures of scale formulas 208. The persistent storage 113 is further shown as containing an upper bound 210 and a lower bound 212 that were determined using the machine learning system 200, the trial subset of training data 206, and the multiple robust measures of scale formulas 208.

The persistent storage 113 is further shown as containing detected outliers 214 in the training data 204 that were detected by using the upper bound 210 and the lower bound 212. The persistent storage 113 is further shown as containing modified training data 216. The modified training data 216 was constructed using the detected outliers 214 and the training data 204.

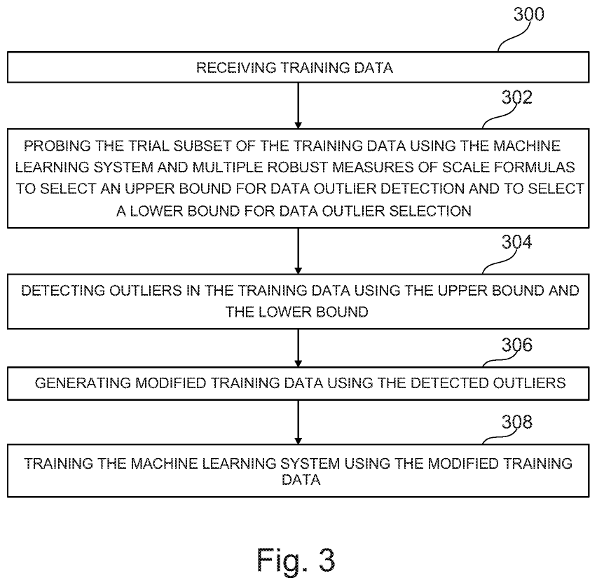

FIG. 3 shows a flowchart which illustrates a method of operating the computing environment 100. In step 300, the training data 204 is received. The training data 204 is data which is used for training the machine learning system 200. Typically, this will be pairs of data including data (trial data) that may be entered into the model and data (ground truth data) which may be compared to the output of the machine learning system. The training data comprises the trial subset 206. The trial subset 206 is a portion or fraction of the training data 204. The trial subset 206 is used for determining the upper bound 210 and the lower bound 216 as described below. The idea behind having a trial subset 206 is that it reduces computational time because only a portion of the data is used.

In step 302, the trial subset 206 of the training data 204 is probed using the machine learning system 200, the trial subset 206 and the multiple robust measures of scale formulas 208 to select an upper bound 210 and a lower bound 212 for data outlier detection.

As an illustration of this probing of the trial subset of the training data, the InterQuartile Range (IQR) is used as an exemplary robust measure of scale formula. The basic IQR formula is:

lower_bound=q1−(1.5*iqr), and

upper_bound=q3+(1.5*iqr).

With lower_bound being the lower bound and upper_bound being the upper bound. This equation can be rewritten as:

lower_bound=p_n1−c*a*iqr,

upper_bound=p_n2+c*b*iqr,
where:
   p_n1=n_th percentile where n∈(0, 25]
   p_n2=n_th percentile where n∈[75,100)
   c is a scaling constant c∈[1,2], c∈R
   a, b are independent scaling constants a,b∈[1,10], a,b∈R.

As a next, step a list of parameter combinations is prepared for a search process to search for the lower_bound and the upper_bound. The number of combinations may in some examples be user-defined, and possibly using existing default values.

For this example, a list of parameters to be varied may be prepared. In one example the list of parameters is [{p_n1}, {p_n2}, {c}, {a}, {b}]

Example of generated parameter combinations:
[20, 85, 1.7, 3.4, 6]
[14, 91, 1.2, 1, 9.5]
[6, 78, 1.54, 2.75, 10]
. . .

In other examples, the constants a, b, and c could have an initial or fixed value that is used when selecting the optimal formula from the multiple robust measure of scale formulas. If for example, the IQR formula is selected then a further search could be performed using all of the parameters listed above.

Next, a search over these combinations is performed using, for example, a grid search algorithm may. For each combination in search, the machine learning model of the machine learning system is trained, and the accuracy score is calculated. The accuracy score may also be referred to as an objective function value (e.g., accuracy, RMSE score).

The accuracy score may be used to find the best performing combination of parameters and may be used to define the formulas for lower and upper bounds.

In the example above, the IQR formula was used. Different robust measure of scale equations such as the Robust Covariance, Local Outlier Factor, standard deviation, median absolute deviation, median absolute deviation, Cauchy distribution, or biweight midvariance may be tried also. The equation which has the highest accuracy score may be selected as an optimal formula. The upper bound 210 and lower bound 212 calculated using the optimal formula may then be used to search for outliers 214 in the training data 204.

In step 304, outliers 214 in the training data 204 are detected using the upper bound 210 and the lower bound 212. In step 306, modified training data 216 is generated or constructed using the detected outliers 214 to modify or label the training data 204. In some examples, the training data 204 detected as being an outlier 214 may be deleted or removed from the training data 204 to construct the modified training data 216. In other examples, training data 204 detected as being an outlier 214 is labeled as being an outlier.

The robust measure of scale equations 208 are used to detect training data 204 which differs from the other training data 204 in a statistically significant way. The expectation is that training data 204 which has a value below the lower bound 212 or above the upper bound 210 has an error or is incorrect.

Trying different robust measure of scale equations 208 and choosing the equation which provides the best accuracy score helps to ensure that an error is not made when detecting outliers in the training data 204. One possibility is that training data 204 detected as outliers 214 is correct. Labeling the outliers 214 instead of removing them from the training data 204 may have the benefit that information in the outliers 214 is not lost.

In step 308, the machine learning system 200 is trained using the modified training data 216.

Various examples may possibly be described by one or more of the following features in the following numbered clauses:

Various examples may possibly be described by one or more of the following features in the following numbered clauses:

Clause 1. A computer implemented method of training a machine learning system, wherein the method comprises:
receiving training data, wherein the training data comprises a trial subset of training data;
probing the trial subset of training data using the machine learning system and multiple robust measures of scale formulas to select an upper bound for data outlier detection and to select a lower bound for data outlier selection,
detecting outliers in the training data using the upper bound and lower bound;
generating modified training data using the detected outliers; and
training the machine learning system using the modified training data.

Clause 2. The computer implemented method of clause 1, wherein the probing comprises selecting an optimal formula from the multiple robust measures of scale formulas by:
determining trial upper and lower bounds using at least multiple of the multiple robust measure of scale formulas;
generating trial training data using the trial upper and lower bounds for the at least multiple robust measure of scale formulas;
training the machine learning system with the trial training data for the at least multiple robust measure of scale formulas; and
determining an accuracy score for the machine learning system trained with the trial training data for the at least multiple robust measure of scale formulas using the training data; and
selecting the optimal formula from the at least multiple robust measure of scale formulas using the accuracy score.

Clause 3. The computer implemented method of clause 2, wherein the optimal formula comprises parameters, wherein the probing comprises optimizing the parameters during iterative training of the machine learning system with the trial subset with variations in the parameters.

Clause 4. The computer implemented method of any one of the preceding clauses, wherein generating modified data using the detected outliers comprises labeling the detected outliers with a missing value imputer, and wherein the machine learning system is configured for handling the missing value imputer during training.

Clause 5. The computer implemented method of clause 4, wherein the missing value imputer is a not-a-number identifier.

Clause 6. The computer implemented method of clause 4 or 5, wherein the machine learning system is a pipeline machine learning system wherein the pipeline machine learning system comprises multiple computational units arranged in a pipeline, wherein the multiple computational units comprise a transformer configured to enable or disable the effect of the missing value imputer on output of the machine learning system.

Clause 7. The computer implemented method of clause 6, wherein the method further comprises:
generating a test group of data from the training data;
testing a first accuracy of the machine learning system with the transformer configured to enable the effect of the missing value imputer using the test group of data;
testing a second accuracy of the machine learning system with the transformer configured to disable the effect of the missing value imputer using the test group of data;
disabling the effect of the missing value imputer in the transformer if the second accuracy is greater than the first accuracy; and
enabling the effect of the missing value imputer in the transformer if the first accuracy is greater than the second accuracy.

Clause 8. The computer implemented method of clause 1, 2, or 3, wherein generating modified training data using the detected outliers comprises deleting training data containing the identified outliers.

Clause 9. The computer implemented method of any one of the preceding clauses, wherein the machine learning system is an automated machine learning system, wherein the automated machine learning system is configured for automatically selecting an optimal machine learning module from multiple machine learning models during training of the machine learning system using the modified training data.

Clause 10. The computer implemented method of any one of the preceding clauses, wherein the multiple robust measures of scale formulas comprise any one of the following: InterQuartile Range, Robust Covariance, Local Outlier Factor, standard deviation, median absolute deviation, median absolute deviation, Cauchy distribution, biweight midvariance, and combinations thereof.

Clause 11. A computer program product comprising a computer-readable storage medium having computer-readable program code embodied therewith, said computer-readable program code configured to implement the method of any one of clauses 1 through 11.

Clause 12. A computer system comprising:
a processor configured for controlling said computer system; and
a memory storing machine executable instructions, execution of said machine executable instructions causes said processor to:
receive training data, wherein the training data comprises a trial subset of training data;
probe the trial subset of training data using the machine learning system and multiple robust measures of scale formulas to select an upper bound for data outlier detection and to select a lower bound for data outlier selection;
detect outliers in the training data using the upper bound and lower bound;
generate modified training data using the detected outliers; and
train the machine learning system using the modified training data.

Clause 13. The computer system of clause 12, wherein the probing comprises selecting an optimal formula from the multiple robust measures of scale formulas by:
determining trial upper and lower bounds using at least multiple of the multiple robust measure of scale formulas;
generating trial training data using the trial upper and lower bounds for the at least multiple robust measure of scale formulas;
training the machine learning system with the trial training data for the at least multiple robust measure of scale formulas; and
determining an accuracy score for the machine learning system trained with the trial training data for the at least multiple robust measure of scale formulas using the training data; and
selecting the optimal formula from the at least multiple robust measure of scale formulas using the accuracy score.

Clause 14. The computer system of clause 13, wherein the optimal formula comprises parameters, wherein the probing comprises optimizing the parameters during iterative training of the machine learning system with the trial subset with variations in the parameters.

Clause 15. The computer system of clause 12, 13, or 14, wherein generating modified data using the detected outliers comprises labeling the detected outliers with a missing value imputer, and wherein the machine learning system is configured for handling the missing value imputer during training.

Clause 16. The computer system of clause 15, wherein the missing value imputer is a not-a-number identifier.

Clause 17. The computer system of clause 15 or 16, wherein the machine learning system is a pipeline machine learning system wherein the pipeline machine learning system comprises multiple computational units arranged in a pipeline, wherein the multiple computational units comprise a transformer configured to enable or disable the effect of the missing value imputer on output of the machine learning system.

Clause 18. The computer system of clause 17, wherein execution of said instructions further causes said processor to:
generating a test group of data from the training data;
testing a first accuracy of the machine learning system with the transformer configured to enable the effect of the missing value imputer using the test group of data;
testing a second accuracy of the machine learning system with the transformer configured to disable the effect of the missing value imputer using the test group of data;
disabling the effect of the missing value imputer in the transformer if the second accuracy is greater than the first accuracy; and
enabling the effect of the missing value imputer in the transformer if the first accuracy is greater than the second accuracy.

Clause 19. The computer system of clause 12, 13, or 14, wherein generating modified training data using the detected outliers comprises deleting training data containing the identified outliers.

Clause 20. The computer system of any one of clauses 12 through 19, wherein the machine learning system is an automated machine learning system, wherein the automated machine learning system is configured for automatically selecting an optimal machine learning module from multiple machine learning models during training of the machine learning system using the modified training data.

Clause 21. The computer system of any one of clauses 12 through 20, wherein the multiple robust measures of scale formulas comprise any one of the following: InterQuartile Range, Robust Covariance, Local Outlier Factor, standard deviation, median absolute deviation, median absolute deviation, Cauchy distribution, biweight midvariance, and combinations thereof.

What is claimed is:

1. A computer-implemented method comprising:
receiving training data comprising a trial subset of training data;
probing the trial subset of training data using a machine learning system and multiple robust measures of scale formulas to select an upper bound for data outlier detection and to select a lower bound for data outlier selection,
detecting one or more outliers in the training data using the selected upper bound and the selected lower bound;
generating modified training data using the detected outliers; and
training the machine learning system utilizing the modified training data.

2. The computer-implemented method of claim 1, wherein the probing comprises selecting an optimal formula from the multiple robust measures of scale formulas by:
determining a trial upper and lower bounds using at least multiple of the multiple robust measure of scale formulas;
generating trial training data using the trial upper and lower bounds for the at least multiple robust measure of scale formulas;
training the machine learning system with the trial training data for the at least multiple robust measure of scale formulas; and
determining an accuracy score for the machine learning system trained with the trial training data for the at least multiple robust measure of scale formulas using the training data; and
selecting the optimal formula from the at least multiple robust measure of scale formulas using the accuracy score.

3. The computer-implemented method of claim 2, wherein the optimal formula comprises parameters and the probing comprises optimizing the parameters during iterative training of the machine learning system with the trial subset with variations in the parameters.

4. The computer-implemented method of claim 1, wherein generating the modified data using the detected outliers comprises labeling the detected outliers with a missing value imputer, and the machine learning system is configured for handling the missing value imputer during training.

5. The computer-implemented method of claim 4, wherein the missing value imputer is a not-a-number identifier.

6. The computer-implemented method of claim 5, wherein the machine learning system is a pipeline machine learning system, and the pipeline machine learning system comprises multiple computational units arranged in a pipeline, wherein the multiple computational units comprise a transformer configured to enable or disable the effect of the missing value imputer on output of the machine learning system.

7. The computer-implemented method of claim 6, further comprising:
generating a test group of data from the training data;
testing a first accuracy of the machine learning system with the transformer configured to enable the effect of the missing value imputer using the test group of data;
testing a second accuracy of the machine learning system with the transformer configured to disable the effect of the missing value imputer using the test group of data;
disabling the effect of the missing value imputer in the transformer if the second accuracy is greater than the first accuracy; and
enabling the effect of the missing value imputer in the transformer if the first accuracy is greater than the second accuracy.

8. The computer-implemented method of claim 3, wherein generating modified training data using the detected outliers comprises deleting training data containing the identified outliers.

9. The computer-implemented method of claim 1, wherein the machine learning system is an automated machine learning system, and the automated machine learning system is configured for automatically selecting an optimal machine learning module from multiple machine learning models during training of the machine learning system using the modified training data.

10. The computer-implemented method of claim 1, wherein the multiple robust measures of scale formulas are selected from the group consisting of InterQuartile Range, Robust Covariance, Local Outlier Factor, standard deviation, median absolute deviation, median absolute deviation, Cauchy distribution, biweight midvariance.

11. A computer program product comprising:
one or more computer readable storage media having computer-readable program instructions stored on the one or more computer readable storage media, said program instructions executes a computer-implemented method comprising steps of:
program instructions to receive training data comprising a trial subset of training data;
program instructions to probe the trial subset of training data using a machine learning system and multiple robust measures of scale formulas to select an upper bound for data outlier detection and to select a lower bound for data outlier selection,
program instructions to detect one or more outliers in the training data using the selected upper bound and the selected lower bound;
program instructions to generate modified training data using the detected outliers; and
program instructions to train the machine learning system utilizing the modified training data.

12. A computer system comprising:
one or more computer processors;
one or more computer readable storage media having computer readable program instructions stored on the one or more computer readable storage media for execution by at least one of the one or more processors, the stored program instructions execute a computer-implemented method comprising steps of:
receiving training data comprising a trial subset of training data;
probing the trial subset of training data using a machine learning system and multiple robust measures of scale formulas to select an upper bound for data outlier detection and to select a lower bound for data outlier selection,
detecting one or more outliers in the training data using the selected upper bound and the selected lower bound;
generating modified training data using the detected outliers; and
training the machine learning system utilizing the modified training data.

13. The computer system of claim 12, wherein the program instructions to probe comprises selecting an optimal formula from the multiple robust measures of scale formulas by:
determining a trial upper and lower bounds using at least multiple of the multiple robust measure of scale formulas;
generating trial training data using the trial upper and lower bounds for the at least multiple robust measure of scale formulas;
training the machine learning system with the trial training data for the at least multiple robust measure of scale formulas; and
determining an accuracy score for the machine learning system trained with the trial training data for the at least multiple robust measure of scale formulas using the training data; and
selecting the optimal formula from the at least multiple robust measure of scale formulas using the accuracy score.

14. The computer system of claim 13, wherein the optimal formula comprises parameters and the probing comprises optimizing the parameters during iterative training of the machine learning system with the trial subset with variations in the parameters.

15. The computer system of claim 12, wherein generating the modified data using the detected outliers comprises labeling the detected outliers with a missing value imputer, and the machine learning system is configured for handling the missing value imputer during training.

16. The computer system of claim 15, wherein the missing value imputer is a not-a-number identifier.

17. The computer system of claim 16, wherein the machine learning system is a pipeline machine learning system, and the pipeline machine learning system comprises multiple computational units arranged in a pipeline, wherein the multiple computational units comprise a transformer configured to enable or disable the effect of the missing value imputer on output of the machine learning system.

18. The computer system of claim 17, wherein the program instructions stored on the one or more computer readable storage media, further comprise the steps of:
generating a test group of data from the training data;
testing a first accuracy of the machine learning system with the transformer configured to enable the effect of the missing value imputer using the test group of data;
testing a second accuracy of the machine learning system with the transformer configured to disable the effect of the missing value imputer using the test group of data;
disabling the effect of the missing value imputer in the transformer if the second accuracy is greater than the first accuracy; and
enabling the effect of the missing value imputer in the transformer if the first accuracy is greater than the second accuracy.

19. The computer system of claim 15, wherein generating modified training data using the detected outliers comprises deleting training data containing the identified outliers.

20. The computer system of claim 12, wherein the machine learning system is an automated machine learning system, and the automated machine learning system is configured for automatically selecting an optimal machine learning module from multiple machine learning models during training of the machine learning system using the modified training data.
